(19) United States
(12) Patent Application Publication
(10) Pub. No.: US 2009/0017391 A1
(43) Pub. Date: Jan. 15, 2009

(54) TONER, METHOD FOR MANUFACTURING THE TONER, AND PROCESS CARTRIDGE USING THE TONER

(76) Inventors: Atsushi Yamamoto, Kawanishi-shi (JP); Chiyoshi Nozaki, Otsu-shi (JP); Tsuyoshi Nozaki, Osaka (JP); Mitsuyo Matsumoto, Osaka (JP); Takuya Kadota, Kobe-shi (JP); Katsunori Kurose, Takarazuka-shi (JP); Yoshimichi Ishikawa, Itami-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/172,378

(22) Filed: Jul. 14, 2008

(30) Foreign Application Priority Data
Jul. 13, 2007 (JP) 2007-183819

(51) Int. Cl. G03G 9/087; G03G 9/00; G03G 15/08

(52) U.S. Cl. 430/108.8; 430/109.4; 430/137.22; 399/258

(57) ABSTRACT

A toner including a colorant, a polyester (I), and an urea-modified polyester is provided. The urea-modified polyester is a reaction product of an isocyanate-modified polyester with an amine. The isocyanate-modified polyester is obtained by modifying a polyester (II) with an isocyanate. The polyester (II) has specific number average molecular weight (Mn) and hydroxyl value [OHV]. The toner can be manufactured by dispersing or emulsifying a toner constituent liquid including the colorant, the polyester (I), and the isocyanate-modified polyester, in an aqueous medium. The toner can be used for a one-component developing device.

### BACKGROUND OF THE INVENTION

1. Field of the Invention

The present invention relates to a toner for use in electrophotography. In addition, the present invention also relates to a method for manufacturing the toner and a process cartridge using the toner.

2. Discussion of the Background

In electrophotography, an electrostatic latent image is formed on a photoreceptor and developed with a developer to form a visible image. The visible image is transferred onto a recording medium such as paper, and fixed thereon by application of heat, pressure, solvent vapor, and the like.

There are various methods for developing an electrostatic latent image. For example, liquid developing methods are known using a liquid developer in which fine particles of pigments, dyes, and the like, are dispersed in a conductive organic liquid. In addition, dry developing methods are also known, such as a cascade method, a magnetic brush method, and power could method, using a dry developer (hereinafter “developer” or “toner”) in which a colorant (such as carbon black) is dispersed in a resin. The dry developing methods are widely used recently.

Demands are increasing for cheap and compact printers and multifunction peripherals (MFP) for use in small offices. To respond to such demands, non-magnetic one-component developing methods are preferably employed in printers and MFPs, because the methods need a smaller number of components. In a typical non-magnetic one-component developing method, for example, a toner control member triboelectrically charges toner particles and applies a thin layer of the toner particles on a toner bearing member simultaneously. The toner control member is in contact with the toner bearing member. The toner particles are then conveyed to a developing area which faces an image bearing member so that an electrostatic latent image on the image bearing member is developed with the toner particles to form a toner image.

Methods for manufacturing toner are broadly classified into pulverization methods and polymerization methods.

In a pulverization method, a thermoplastic resin, a colorant, a charge controlling agent, an offset inhibitor, and the like, are evenly melt-mixed, and the mixture is then subjected to pulverization and classification. The pulverization method is capable of manufacturing a toner having a certain level of desired properties. However, there is a drawback that materials usable for the pulverization method are limited. For example, the toner composition is required to be treatable by an economical pulverization and classification apparatus. Therefore, the toner composition needs to be brittle. However, a brittle toner composition tends to produce particles with a broad particle diameter distribution by pulverization. To produce a copy image having good resolution and gradation, fine particles having a particle diameter of 4 μm or less and coarse particles having a particle diameter of 15 μm or more need to be removed, resulting in low yield. Furthermore, it is difficult to evenly disperse a colorant, a charge controlling agent, and the like agent, in a thermoplastic resin by the pulverization method. Therefore, fluidity, developability, and durability of the resultant toner and image quality of the resultant image may deteriorate.

In attempting to solve the above-described problems of the pulverization method, polymerization methods have been proposed. For example, suspension polymerization methods and emulsion aggregation methods, such as the method disclosed in Japanese Patent No. 2537503, are known.

However, toners including a polyester resin, which may have good fixing ability at low temperatures, are difficult to manufacture by the polymerization methods.

In attempting to use polyester resins for non-pulverization methods, Unexamined Japanese Patent Application Publication No. (hereinafter “JP-A”) 09-034167 discloses one possible method for manufacturing toner. In this method, first, toner compositions including a polyester resin are pulverized into particles, and the particles are then dispersed in an aqueous medium and treated with a solvent, so that spherical toner particles are formed. As another approach, JP-A 11-149180 discloses a method for manufacturing toner using an isocyanate reaction in an aqueous medium.

Recent toners tend to use a binder resin including both low-molecular-weight and high-molecular-weight components having separate functions of imparting fixing ability at low temperatures (hereinafter “low-temperature fixability”) and resistance to offset problems that occur at high temperatures (hereinafter “hot offset resistance”), respectively.

When such a toner is used for the non-magnetic one-component developing method, the following phenomenon may occur. Because the toner control member gives sufficient charge to toner particles by friction, the toner control member needs to contact the toner bearing member with a certain degree of pressure. Such a configuration may break or deform the toner particles in continuous developing. The broken or deformed toner particles may strongly adhere to the toner control member, thereby degrading charging performance of the toner control member. Consequently, the resultant image may have linear image noise, uneven image density, and background fouling in that the background portion of an image is soiled with toner particles.

To prevent the toner from being broken or deformed by application of pressure or frictional stress from the toner control member, one proposed approach involves adding a high-molecular-weight or highly-cross-linked resin to the toner so as to have proper viscoelasticity without degrading fixing ability. For example, JP-A 2004-302442 discloses a toner including an ultrahigh-molecular-weight resin with high stiffness and elasticity, manufactured using an isocyanate elongation reaction in an aqueous medium. However, the stiffness and elasticity are not sufficient enough for use in one-component developing methods.

JP-A 2006-350319 discloses a toner in which the condition of cross-linking of binder resin is controlled by controlling the molecular weight of an isocyanate-modified polyester. Low-temperature fixability of such a toner is good, but stiffness thereof is not sufficient enough for use in the one-component developing methods, because the distance between cross-linking points is too long, and the molecular weight of an original polyester, from which the isocyanate-modified polyester is derived, is insufficiently controlled.

### SUMMARY OF THE INVENTION

Accordingly, an object of the present invention is to provide a toner which has good combination of low-temperature fixability and hot offset resistance, and is resistant to mechanical stress applied in one-component developing methods.

Another object of the present invention is to provide a method for manufacturing the toner.

Yet another object of the present invention is to provide a process cartridge which reliably produces high quality images.

These and other objects of the present invention, either individually or in combinations thereof, as hereinafter will become more readily apparent can be attained by a toner, comprising:

a colorant;

a polyester (I); and

an urea-modified polyester,

wherein the urea-modified polyester is a reaction product of an isocyanate-modified polyester with an amine,

the isocyanate-modified polyester is obtained by modifying a polyester (II) with an isocyanate, and

the polyester (II) has a number average molecular weight (Mn) and a hydroxyl value [OHV] satisfying the following equations:

1500≦Mn≦4000

2.3≦[OHV]/1000/56.1×Mn≦3.5;

and a method for manufacturing the toner and a process cartridge using the toner.

### BRIEF DESCRIPTION OF THE DRAWINGS

These and other objects, features and advantages of the present invention will become apparent upon consideration of the following description of the preferred embodiments of the present invention taken in conjunction with the accompanying drawings, wherein:

FIG. 1 is a graph showing an endothermic curve of a paraffin wax used in Examples, obtained by a differential scanning calorimeter; and

FIG. 2 is a schematic view illustrating an embodiment of a process cartridge of the present invention.

### DETAILED DESCRIPTION OF THE INVENTION

The present invention provides a toner comprising a binder resin which comprises both low-molecular-weight and high-molecular-weight components. The high-molecular-weight components have a high cross-linking density so that the resultant toner has proper elasticity. Such a toner is capable of absorbing mechanical stress repeatedly applied in the one-component developing method, and therefore the toner hardly deteriorates. On the other hand, the low-molecular-weight components, which have a different function from the high-molecular-weight components, enable the toner to be normally fixed on paper.

Specifically, the toner of the present invention is manufactured by dispersing or emulsifying a toner constituent liquid comprising a colorant, a polyester (I), and a polyester (II) modified with an isocyanate (hereinafter “isocyanate-modified polyester (A)”), in an aqueous medium. The polyester (II) has a number average molecular weight (Mn) and a hydroxyl value [OHV] satisfying the following equations (1) and (2):

1500≦Mn≦4000 (1)

2.3≦[OHV]/1000/56.1×Mn≦3.5 (2)

The polyester (II) is a precursor of the isocyanate-modified polyester (A). When the polyester (II) satisfies the equation (1), in other words, the polyester (II) has a proper number average molecular weight (Mn), the resultant toner has proper elasticity and chargeability for use in electrophotography.

The number average molecular weight (Mn) of the polyester (II) is from 1500 to 4000, preferably from 2000 to 4000, and more preferably from 2000 to 3500.

When the Mn of the polyester (II) is too small, cross-linking density in the resultant toner may be too large. Such a toner is too elastic to fluidize even when heat is applied thereto, resulting in poor fixing ability on paper. Furthermore, when the Mn is too small, a large number of urea or urethane bonds are formed by elongation reactions of isocyanates. Since the urea and urethane bonds tend to adversely affect chargeability of the resultant toner, background fouling may be caused in the resultant image.

Even if the amount of the isocyanate-modified polyester (A) is reduced to avoid an occurrence of the above-described phenomena, the isocyanate-modified polyester (A) and the polyester (I) may be phase-separated in the resultant toner due to low compatibility therebetween. Such a toner is too fragile for use in the one-component developing method.

By contrast, when the Mn is too large, cross-linking density in the resultant toner may be too small. In other words, the isocyanate-modified polyester (A) does not express elasticity very much. Consequently, the toner may be partially or entirely deformed by application of mechanical stress in the one-component developing method. In this case, a wax may bleed out from the toner and contaminate the toner control blade, resulting in production of abnormal images with undesired lines.

The equation (2) defines a relation of the hydroxyl value and the number average molecular weight of the polyester (II). The following description will be made with an assumption that the polyester (II) is a linear polymer. The number of molecular chains existing in 1 g of the polymer is:

1/Mn (mol)

where Mn represents the number average molecular weight of the polymer. On the other hand, since the hydroxyl value [OHV] is defined as a weight (mg) of KOH needed to titrate hydroxyl groups existing in 1 g of the polymer, the number of hydroxyl groups existing in 1 g of the polymer is:

[OHV]/1000/56.1 (mol)

Therefore, the number f of hydroxyl groups existing in one molecular chain is represented by the following equation:

f=[OHV]/1000/56.1×Mn

When the number f is 2, it is considered that a molecular chain has hydroxyl groups (i.e., —OH) on both ends. When these hydroxyl groups on both ends are modified with a diisocyanate such as isophorone diisocyanate, the polyester becomes an isocyanate-modified polyester having isocyanate groups (i.e., —NCO) on both ends. When the isocyanate-modified polyester reacts with a compound having 2 active hydrogens such as isophoronediamine, the isocyanate-modified polyester and the compound may elongate by forming bonds therebetween, resulting in formation of a high-molecular-weight polymer.

When the number f is greater than 2, part of molecular chains have 3 or more hydroxyl groups. Therefore, when such an isocyanate-modified polyester reacts with a compound having 2 active hydrogens, a cross-linking structure may be formed.

When the number f is less than 2, part of the molecular chains have only 1 or no hydroxyl group. Therefore, such an isocyanate-modified polyester terminates the elongation reaction or never elongates.

Accordingly, the number f is preferably 2 or more so that the resultant toner has a cross-linking structure expressing proper elasticity.

As described above, in the one-component developing method, the toner control member gives sufficient charge to toner particles by friction. Therefore, the toner control member needs to contact the toner bearing member with a certain degree of pressure. Such a configuration may break or deform the toner particles in continuous developing, if the toner particles have low elasticity. The broken or deformed toner particles may strongly adhere to the toner control member, thereby degrading charging performance of the toner control member. Consequently, the resultant image may have linear image noise, uneven image density, and background fouling in that the background portion of an image is soiled with toner particles.

To overcome mechanical stresses applied in the one-component developing method, the number f is preferably 2.3 or more, and more preferably 2.5 or more. When the number f is too small, the toner may have too small an elasticity. In this case, a wax may bleed out from the toner and contaminate the toner control blade, resulting in production of abnormal images with undesired lines.

On the other hand, the number f is preferably 3.5 or less, and more preferably 3.2 or less. When the number f is too large, the toner may be too elastic to fluidize even when heat is applied thereto, resulting in poor fixing ability on paper.

In the present invention, the number average molecular weight (Mn) is defined as a molecular weight determined by gel permeation chromatography (GPC) using styrene as a standard substance. Therefore, when a sample has a cross-linking or branched structure, the measured molecular weight may be smaller than the actual molecular weight in principle. Accordingly, the number f may be also smaller than the actual number of hydroxyl groups. Even when these facts are taken into consideration, the polyester (II) satisfying the equation (2) provides the toner of the present invention.

In the present invention, the acid value of a resin is measured according to JIS K1557-1970. First, about 2 g of a pulverized sample is precisely weighed. (The weight of a sample is defined as W (g)). The weighed sample is contained in a 200-ml conical flask, and dissolved in 100 ml of a mixed solvent, in which toluene and ethanol are mixed at a ratio of 2:1, for 5 hours. When the sample is insoluble in the mixed solvent, dioxane or THF may be added. A solution of phenolphthalein, which is an indicator, is further added to the above sample solution, and titrated with a 0.1 N KOH alcohol solution using a burette. When the volume of the KOH solution needed for titration of the sample solution is defined as S (ml) and that of blank is defined as B (ml), the acid value [AV] is calculated by the following equation:

[AV]=[(S−B)×f×5.61]/W

wherein f is the factor of the KOH solution.

In the present invention, the hydroxyl value of a resin is measured as follows. First, 0.5 g of a sample is precisely weighed and contained in a 100-ml volumetric flask, and 5 ml of an acetylating agent is added thereto. The mixture is heated to 100±5° C. in a bath and left for 1 to 2 hours. The flask is taken out of the bath and stands to cool. Thereafter, water is added to the flask and the flask is shaken so that acetic anhydride is decomposed. To completely decompose acetic anhydride, the flask is heated in the bath again for 10 minutes and allowed to stand to cool. The inner wall of the flask is washed with an organic solvent. The liquid in the flask is potentiometrically titrated with an N/2 ethyl alcohol solution of potassium hydroxide using an electrode, according to JIS K0070-1966.

The number average molecular weight (Mn) of the polyester (II) can be measured by gel permeation chromatography (GPC) under the following conditions.

Measurement Instrument: GPC-150C (from Waters Corporation)

Column: SHODEX® KF 801 to 807 (from Showa Denko K.K.)

Temperature: 40° C.

Solvent: THF (tetrahydrofuran)

Flow rate: 1.0 mL/min

Sample Concentration: 0.05 to 0.6%

Injection Volume: 0.1 ml

The number average molecular weight (Mn) is calculated from a molecular weight distribution measured above, using a calibration curve prepared with monodisperse polystyrene standard samples. As the monodisperse polystyrene standard samples, SHODEX® STANDARD S-7300, S-210, S-390, S-875, S-1980, S-10.9, S-629, S-3.0, S-0.580, and toluene (from Showa Denko K.K.) are preferably used, although any grouping of monodisperse polystyrene standard samples can be used for calibration. The detector is a refractive index (RI) detector.

Next, the method for manufacturing a toner of the present invention will be described in detail.

First, a toner constituent liquid will be described. The toner constituent liquid is prepared by dissolving or dispersing toner constituents, such as a colorant, the polyester (I), and the isocyanate-modified polyester (A), in an organic solvent.

As the organic solvent, any solvents capable of dissolving or dispersing the toner constituents can be used. Preferably, the organic solvent has a boiling point less than 150° C. because of being easily removable.

Specific examples of usable organic solvent include, but are not limited to, toluene, xylene, benzene, carbon tetrachloride, methylene chloride, 1,2-dichloroethane, 1,1,2-trichloroethane, trichloroethylene, chloroform, monochlorobenzene, methyl acetate, ethyl acetate, methyl ethyl ketone, acetone, and tetrahydrofuran. These organic solvents can be used alone or in combination. Among these organic solvents, methyl acetate and ethyl acetate are preferably used, because these solvents are highly volatile. The amount of the organic solvent is typically from 40 to 300 parts by weight, preferably from 60 to 140 parts by weight, and more preferably from 80 to 120 parts by weight, per 100 parts by weight of solid components of the toner constituents.

The isocyanate-modified polyester (A) used for the present invention is prepared by, for example, reacting the polyester (II), which is a polycondensation product of a polyol (1) and a polycarboxylic acid (2), with a polyisocyanate (3). The polyester (II) satisfies the following equations (1) and (2):

1500≦Mn≦4000 (1)

2.3≦[OHV]/1000/56.1×Mn≦3.5 (2)

As the polyol (1), diols (1-1) and polyols (1-2) having 3 or more valences can be used. A diol (1-1) alone, and a mixture of a diol (1-1) with a small amount of a polyol (1-2) are preferably used.

Specific examples of usable diols (1-1) include, but are not limited to, alkylene glycols (e.g., ethylene glycol, 1,2-propylene glycol, 1,3-propylene glycol, 1,4-butanediol, 1,6-hexanediol), alkylene ether glycols (e.g., diethylene glycol, triethylene glycol, dipropylene glycol, polyethylene glycol, polypropylene glycol, polytetramethylene ether glycol), alicyclic diols (e.g., 1,4-cyclohexanedimethanol, hydrogenated bisphenol A), bisphenols (e.g., bisphenol A, bisphenol F, bisphenol S), alkylene oxide (e.g., ethylene oxide, propylene oxide, butylene oxide) adducts of the above-described alicyclic diols; and alkylene oxide (e.g., ethylene oxide, propylene oxide, butylene oxide) adducts of the above-described bisphenols. Among these compounds, alkylene glycols having 2 to 12 carbon atoms and alkylene oxide adducts of bisphenols are preferably used, and combinations of alkylene oxide adducts of bisphenols with alkylene glycols having 2 to 12 carbon atoms are more preferably used.

Specific examples of usable polyols (1-2) having 3 or more valences include, but are not limited to, polyvalent aliphatic alcohols having 3 or more valences (e.g., glycerin, trimethylolethane, trimethylolpropane, pentaerythritol, sorbitol), phenols having 3 or more valences (e.g., trisphenol PA, phenol novolac, cresol novolac), and alkylene oxide adducts of polyphenols having 3 or more valences.

As the polycarboxylic acid (2), dicarboxylic acids (2-1) and polycarboxylic acids (2-2) having 3 or more valences can be used. A dicarboxylic acid (2-1) alone, and a mixture of a dicarboxylic acid (2-1) with a small amount of a polycarboxylic acid (2-2) having 3 or more valences are preferably used.

Specific examples of usable dicarboxylic acids (2-1) include, but are not limited to, alkylene dicarboxylic acids (e.g., succinic acid, adipic acid, sebacic acid), alkenylene dicarboxylic acids (e.g., maleic acid, fumaric acid), and aromatic dicarboxylic acids (e.g., phthalic acid, isophthalic acid, terephthalic acid, naphthalenedicarboxylic acid). Among these compounds, alkenylene dicarboxylic acids having 4 to 20 carbon atoms and aromatic dicarboxylic acids having 8 to 20 carbon atoms are preferably used.

Specific examples of usable polycarboxylic acids (2-2) having 3 or more valences include, but are not limited to, aromatic polycarboxylic acids having 9 to 20 carbon atoms (e.g., trimellitic acid, pyromellitic acid).

Furthermore, acid anhydrides and lower alkyl esters (e.g., methyl ester, ethyl ester, isopropyl ester) of the above-described compounds may be reacted with the polyols (1), to prepare the polycarboxylic acid (2).

To prepare a polyester having alcoholic hydroxyl groups on both ends, the equivalent ratio ([OH]/[COOH]) of hydroxyl group [OH] of the polyol (1) to carboxyl group [COOH] of the polycarboxylic acid (2) is typically from 2/1 to 1/1, preferably from 1.5/1 to 1/1, and more preferably from 1.3/1 to 1.02/1.

The polyisocyanate (3) reacts with alcoholic hydroxyl groups of the polyester described above to prepare an isocyanate-modified polyester. Specific examples of usable polyisocyanates (3) include, but are not limited to, aliphatic polyisocyanates (e.g., tetramethylene diisocyanate, hexamethylene diisocyanate, 2,6-diisocyanatomethylcaproate), alicyclic polyisocyanates (e.g., isophorone diisocyanate, cyclohexylmethane diisocyanate), aromatic diisocyanates (e.g., tolylene diisocyanate, diphenylmethane diisocyanate), aromatic aliphatic diisocyanates (e.g., α,α,α′,α′-tetramethylxylylene diisocyanate), isocyanurates, and the above-described polyisocyanates blocked with phenol derivatives, oxime, caprolactam, etc. These compounds can be used alone or in combination.

The equivalent ratio ([NCO]/[OH]) of isocyanate group [NCO] in the polyisocyanate (3) to hydroxyl group [OH] in the polyester is typically from 5/1 to 1/1, preferably from 4/1 to 1.2/1, and more preferably from 2.5/1 to 1.5/1. When the equivalent ratio is too large, low-temperature fixability of the resultant toner may deteriorate. When the equivalent ratio is too small, the resultant modified polyester may include too small an amount of urea bonds. Therefore, the resultant toner may easily adhere to the toner control blade and hot offset resistance thereof may deteriorate.

It is important that the isocyanate-modified polyester (A) is used in combination with the polyester (I), which is unreactive. The combination of the isocyanate-modified polyester (A) with the polyester (I) provides a toner having low-temperature fixability and capable of producing highly glossy full-color images.

As the polyester (I), polycondensation products of the polyols (1) with the polycarboxylic acids (2) described above can be used, as well as the polyester (II). The polyester (I) may include chemical bonds other than an urea bond, for example, an urethane bond. Preferably, the isocyanate-modified polyester (A) and the polyester (I) are partially or entirely compatible with each other, from the viewpoint of improving low-temperature fixability and hot offset resistance. Therefore, the isocyanate-modified polyester (A) and the polyester (I) preferably have similar compositions. The weight ratio ((A)/(I)) of the isocyanate-modified polyester (A) to the polyester (I) is typically from 5/95 to 75/25, preferably from 10/90 to 25/75, more preferably from 12/88 to 25/75, and much more preferably from 12/88 to 22/78. When the weight ratio is too small, hot offset resistance, thermostable preservability, and low-temperature fixability of the resultant toner may deteriorate.

A gel permeation chromatogram of the polyester (I) preferably has a peak in a molecular weight range of from 1000 to 30000, preferably from 1500 to 10000, and more preferably from 2000 to 8000. When the peak is present at too small a molecular weight, the resultant toner may have poor thermostable preservability. When the peak is present at too large a molecular weight, the resultant toner may have poor low-temperature fixability. The polyester (I) preferably has a number average molecular weight of from 1500 to 4000 and a weight average molecular weight of from 4000 to 10000.

The polyester (I) preferably has a hydroxyl value of 5 mgKOH/g or more, more preferably from 10 to 120 mgKOH/g, and much more preferably from 20 to 80 mgKOH/g. When the hydroxyl value is too small, the resultant toner may not satisfy thermostable preservability and low-temperature fixability simultaneously. The polyester (I) typically has an acid value of from 18 to 40 mgKOH/g, and preferably from 20 to 35 mgKOH/g. When the acid value is too large, the resultant toner may be adversely affected in high-temperature and high-humidity conditions and low-temperature and low-humidity conditions, resulting in deterioration of the resultant image quality. When the acid value is too small, the resultant toner may have poor affinity with paper, resulting in poor fixing ability.

The isocyanate-modified polyester (A) is subjected to an elongation and/or cross-linking reaction to become a high-molecular-weight polymer.

The elongation and/or cross-linking reaction may be a reaction between amino groups formed by the hydrolysis of isocyanate groups on both ends of the isocyanate-modified polyester (A) and isocyanate groups remaining therein. Alternatively, isocyanate groups of the isocyanate-modified polyester (A) may be bound with a compound having active hydrogen.

For example, amines (B) can be used as a compound having active hydrogen. As the amines (B), diamines (B1), polyamines (B2) having 3 or more valences, amino alcohols (B3), amino mercaptans (B4), amino acids (B5), and blocked amines (B6) in which the amino groups in the amines (B1) to (B5) are blocked, can preferably be used.

Specific examples of usable diamines (B1) include, but are not limited to, aromatic diamines (e.g., phenylenediamine, diethyltoluenediamine, 4,4′-diaminodiphenylmethane), alicyclic diamines (e.g., 4,4′-diamino-3,3′-dimethyldicyclohexylmethane, diamine cyclohexane, isophoronediamine), and aliphatic diamines (e.g., ethylenediamine, tetramethylenediamine, hexamethylenediamine).

Specific examples of usable polyamines (B2) having 3 or more valences include, but are not limited to, diethylenetriamine and triethylenetetramine.

Specific examples of usable amino alcohols (B3) include, but are not limited to, ethanolamine and hydroxyethylaniline.

Specific examples of usable amino mercaptans (B4) include, but are not limited to, aminoethyl mercaptan and aminopropyl mercaptan.

Specific examples of usable amino acids (B5) include, but are not limited to, aminopropionic acid and aminocaproic acid.

Specific examples of usable blocked amines (B6) include, but are not limited to, ketimine compounds prepared by reacting the amines (B1) to (B5) with ketones such as acetone, methyl ethyl ketone, and methyl isobutyl ketone; and oxazoline compounds.

Among these compounds, a diamine (B1) alone, and a mixture of a diamine (B1) with a small amount of a polyamine (B2) are preferably used.

The molecular weight of the resultant modified polyester may be controlled by the cross-linking and/or elongation agent or a reaction terminator, if desired. Specific examples of usable reaction terminators include, but are not limited to, monoamines (e.g., diethylamine, dibutylamine, butylamine, laurylamine) and blocked compounds thereof (e.g., ketimine compounds).

In addition, tertiary amine compounds, such as amines, amino alcohols, amino mercaptans, and amidines, can be used as a catalyst of the cross-linking and/or elongation reaction. Specific examples of usable amines include, but are not limited to, aromatic amines (e.g., triphenylamine, triarylamine), alicyclic amines (e.g., N-methylpiperidine), and aliphatic amines (e.g., triethylamine, trimethylamine). Specific examples of usable amino alcohols include, but are not limited to, triethanolamine and dihydroxyethyl aniline. Specific examples of usable amino mercaptans include, but are not limited to, triethanethiol amine and trimethanethiol amine. Specific examples of usable amidines include, but are not limited to, DBU (1,8-diaza-bicyclo[5.4.0]undecane-7) and DBN (1,5-diaza-bicyclo[4.3.0]nonene-5). Among these tertiary amine compounds the following compound (I) is preferably used:

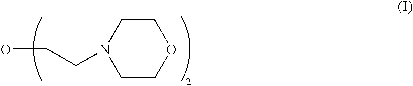

As described above, the binder resin of the toner of the present invention includes a urea-modified polyester resin produced by a reaction between the isocyanate-modified polyester (A) and the amine (B), and the polyester (I). The binder resin typically has a glass transition temperature (Tg) of from 40 to 70° C., and preferably from 45 to 55° C. When the Tg is too small, thermostable preservability of the resultant toner may deteriorate. When the Tg is too large, low-temperature fixability of the resultant toner may deteriorate. The toner of the present invention has better thermostable preservability compared to typical polyester-based toners, even if the glass transition temperature is lower, because of including a cross-linked and/or elongated polyester resin.

With regard to storage elastic modulus, the toner of the present invention has a temperature TG′, at which the storage elastic modulus (G′) is 1000 Pa at a measurement frequency of 20 Hz, of 100° C. or more, and preferably from 110 to 200° C. When the TG′ is too small, thermostable preservability of the resultant toner may deteriorate.

With regard to viscosity, the toner of the present invention has a temperature Tη, at which the viscosity (η) is 1000 Pa at a measurement frequency of 20 Hz, of 180° C. or less, and preferably from 90 to 160° C. When the Tη is too large, low-temperature fixability of the resultant toner may deteriorate.

From the viewpoint of satisfying both low-temperature fixability and hot offset resistance, TG′ is preferably larger than Tη. In other words, a difference between TG′ and Tη (i.e., TG′−Tη) is preferably 0° C. or more, more preferably 10° C. or more, and much more preferably 20° C. or more. The difference is preferably as large as possible.

On the other hand, from the viewpoint of satisfying both thermostable preservability and low-temperature fixability, the difference between TG′ and Tη (i.e., TG′−Tη) is preferably from 0 to 100° C. more preferably from 10 to 90° C., and much more preferably from 20 to 80° C.

Next, an aqueous medium will be described in detail. The aqueous medium for use in the present invention preferably contains a particulate resin, to be described in detail later. As the aqueous medium, water and a mixture of water and a solvent miscible with water are preferably used. Specific examples of usable water-miscible solvents include, but are not limited to, alcohols (e.g., methanol, isopropanol, ethylene glycol), dimethylformamide, tetrahydrofuran, cellosolve, and lower ketones (e.g., acetone, methyl ethyl ketone). These solvents can be used alone or in combination.

Any thermoplastic and thermostable resins capable of forming an aqueous dispersion thereof can be used for the particulate resin contained in the aqueous medium. Specific examples of such resins include, but are not limited to, vinyl resins, polyurethane resins, epoxy resins, polyester resins, polyamide resins, polyimide resins, silicone resins, phenol resins, melamine resins, urea resins, aniline resins, ionomer resins, and polycarbonate resins. These resins can be used alone or in combination. Among these resins, vinyl resins, polyurethane resins, epoxy resins, polyester resins, and combinations thereof are preferably used because aqueous dispersions thereof are easily obtainable.

The vinyl resin is a homopolymer or copolymer of vinyl monomers. Specific examples of the vinyl monomers include, but are not limited to, the following compounds (1) to (10).
(1) Vinyl hydrocarbons:
aliphatic vinyl hydrocarbons such as alkenes (e.g., ethylene, propylene, butene, isobutylene, pentene, heptene, diisobutylene, octene, dodecene, octadecene, α-olefins) and alkadienes (e.g., butadiene, isoprene, 1,4-pentadiene, 1,6-hexadiene, 1,7-octadiene);
alicyclic vinyl hydrocarbons such as mono- or di-cycloalkenes and alkadienes (e.g., cyclohexene, (di)cyclopentadiene, vinylcyclohexene, ethylidene bicycloheptene) and terpenes (e.g., pinene, limonene, indene); and
aromatic vinyl hydrocarbons such as styrenes and hydrocarbyl (such as alkyl, cycloalkyl, aralkyl, and/or alkenyl) substitutions thereof (e.g., α-methylstyrene, vinyltoluene, 2,4-dimethylstyrene, ethylstyrene, isopropylstyrene, butylstyrene, phenylstyrene, cyclohexylstyrene, benzylstyrene, crotylbenzene, divinylbenzene, divinyltoluene, divinylxylene, trivinylbenzene) and divinylnaphthalene.
(2) Vinyl monomers having carboxyl group and salts thereof:
unsaturated monocarboxylic and dicarboxylic acids having 3 to 30 carbon atoms and anhydrides and monoalkyl (C1-C24) esters thereof (e.g., acrylic acid, methacrylic acid, maleic acid, maleic anhydride, monoalkyl maleate, fumaric acid, monoalkyl fumarate, crotonic acid, itaconic acid, monoalkyl itaconate, itaconic acid glycol monoether, citraconic acid, monoalkyl citraconate, cinnamic acid).
(3) Vinyl monomers having sulfonyl groups, vinyl sulfate monoesters, and salts thereof:
alkene sulfonic acids having 2 to 14 carbon atoms (e.g., vinyl sulfonic acid, (meth)allyl sulfonic acid, methylvinyl sulfonic acid, styrene sulfonic acid) and alkyl derivatives thereof having 2 to 24 carbon atoms (e.g., α-methylstyrene sulfonic acid), sulfo(hydroxy)alkyl(meth)acrylates and (meth)acrylamides (e.g., sulfopropyl(meth)acrylate, 2-hydroxy-3-(meth)acryloxypropyl sulfonic acid, 2-(meth)acryloylamino-2,2-dimethylethane sulfonic acid, 2-(meth)acryloyloxyethane sulfonic acid, 3-(meth)acryloyloxy-2-hydroxypropane sulfonic acid, 2-(meth)acrylamide-2-methylpropane sulfonic acid, 3-(meth)acrylamide-2-hydroxypropane sulfonic acid, alkyl(C3-C18)allyl sulfosuccinic acid, sulfate esters of poly(2≦n≦30)oxyalkylene(ethylene, propylene, butylene) (which may be a homopolymer, random copolymer, or block copolymer) mono(meth)acrylate [e.g., sulfate esters of poly(5≦n≦15)oxypropylene monomethacrylate], sulfate esters of polyoxyethylene polycyclic phenyl ethers), and the following compounds (i) to (iii):

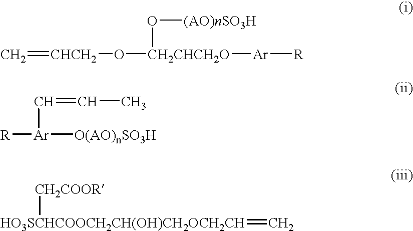

wherein R represents an alkyl group having 1 to 15 carbon atoms; A represents an alkylene group having 2 to 4 carbon atoms; Ar represents a benzene ring; R′ represents an alkyl group having 1 to 15 carbon atoms which may substituted with fluorine; n represents an integer of from 1 to 50; when n is 2 or more, multiple A's may be, but need not necessarily be, the same; when multiple A's are different, multiple A's may be in random or block configuration.
(4) Vinyl monomers having phosphate group and salts thereof:
(meth)acryloyloxyalkyl phosphate monoesters (e.g., 2-hydroxyethyl(meth)acryloyl phosphate, phenyl-2-acryloyloxyethyl phosphate) and (meth)acryloyloxyalkyl(C1-C24) phosphonic acids (e.g., 2-acryloyloxyethyl phosphonic acid).

Salts of the compounds (2) to (4) include alkali metal salts (e.g., sodium salt, potassium salt), alkaline-earth metal salts (e.g., calcium salt, magnesium salt), ammonium salt, amine salt, and tertiary ammonium salt.
(5) Vinyl monomers having hydroxyl group:
hydroxystyrene, N-methylol(meth)acrylamide, hydroxyethyl(meth)acrylate, hydroxypropyl(meth)acrylate, polyethyleneglycol mono(meth)acrylate, (meth)allyl alcohol, crotyl alcohol, isocrotyl alcohol, 1-butene-3-ol, 2-butene-1-ol, 2-butene-1,4-diol, propargyl alcohol, 2-hydroxyethyl propenyl ether, and sucrose allyl ether.
(6) Vinyl monomers having nitrogen:
vinyl monomers having amino group such as aminoethyl(meth)acrylate, dimethylaminoethyl(meth)acrylate, diethylaminoethyl(meth)acrylate, t-butylaminoethyl methacrylate, N-aminoethyl(meth)acrylamide, (meth)allylamine, morpholinoethyl(meth)acrylate, 4-vinylprydine, 2-vinylpyridine, crotylamine, N,N-dimethylaminostyrene, methyl-α-acetoamino acrylate, vinylimidazole, N-vinyl pyrrole, N-vinyl thiopyrrolidone, N-arylphenylenediamine, aminocarbazole, aminothiazole, aminoindole, aminopyrrole, aminoimidazole, aminomercaptothiazole, and salts thereof;
vinyl monomers having amide group such as (meth)acrylamide, N-methyl(meth)acrylamide, N-butyl acrylamide, diacetone acrylamide, N-methylol(meth)acrylamide, N,N-methylene-bis(meth)acrylamide, cinnamic acid amide, N,N-dimethyl acrylamide, N,N-dibenzyl acrylamide, methacryl formamide, N-methyl-N-vinyl acetoamide, N-vinyl pyrrolidone;
vinyl monomers having nitrile group such as (meth)acrylonitrile, cyanostyrene, cyanoacrylate; vinyl monomers having quaternary ammonium cation group such as dimethylaminoethyl(meth)acrylate, diethylaminoethyl(meth)acrylate, dimethylaminoethyl(meth)acrylamide, diethylaminoethyl(meth)acrylamide, quaternated compounds of vinyl monomers (such as diallyl amine) having tertiary amine group using quaternating agents (such as methyl chloride, dimethyl sulfuric acid, benzyl chloride, dimethyl carbonate); and
vinyl monomers having nitro group such as nitrostyrene.
(7) Vinyl monomers having epoxy group:
glycidyl(meth)acrylate, tetrahydrofurfuryl(meth)acrylate, and p-vinylphenylphenyl oxide.
(8) Vinyl esters, vinyl (thio)ethers, vinyl ketones, and vinyl sulfones:
vinyl esters such as vinyl acetate, vinyl butyrate, vinyl propionate, vinyl butyrate, diallyl phthalate, diallyl adipate, isopropenyl acetate, vinyl methacrylate, methyl-4-vinyl benzoate, cyclohexyl methacrylate, benzyl methacrylate, phenyl(meth)acrylate, vinylmethoxy acetate, vinyl benzoate, ethyl-α-ethoxy acrylate, alkyl(C1-C50) (meth)acrylates (e.g., methyl(meth)acrylate, ethyl(meth)acrylate, propyl(meth)acrylate, butyl(meth)acrylate, 2-ethylhexyl(meth)acrylate, dodecyl(meth)acrylate, hexadecyl(meth)acrylate, heptadecyl(meth)acrylate, eicosyl(meth)acrylate), dialkyl(C2-C8, in straight chain, branched chain, or alicyclic structure) fumarates, dialkyl(C2-C8, in straight chain, branched chain, or alicyclic structure) maleates, poly(meth)allyloxyalkanes (e.g., diallyloxyethane, triallyloxyethane, tetraallyloxyethane, tetraallyloxypropane, tetraallyloxybutane, tetramethallyloxyethane), vinyl monomers having polyalkylene glycol chain (e.g., polyethylene glycol (molecular weight: 300) mono(meth)acrylate, polypropylene glycol (molecular weight: 500) monoacrylate, ethylene oxide 10 mol adduct of methyl alcohol (meth)acrylate, ethylene oxide 30 mol adduct of lauryl alcohol (meth)acrylate), and poly(meth)acrylates (e.g., poly(meth)acrylates of polyvalent alcohols, ethylene glycol di(meth)acrylate, propylene glycol di(meth)acrylate, neopentyl glycol di(meth)acrylate, trimethylolpropane tri(meth)acrylate, polyethylene glycol di(meth)acrylate);
vinyl (thio) ethers such as vinyl methyl ether, vinyl ethyl ether, vinyl propyl ether, vinyl butyl ether, vinyl-2-ethylhexyl ether, vinyl phenyl ether, vinyl-2-methoxyethyl ether, methoxybutadiene, vinyl-2-butoxyethyl ether, 3,4-dihydro-1,2-pyran, 2-butoxy-2′-vinyloxydiethyl ether, vinyl-2-ethylmercaptoethyl ether, acetoxystyrene, and phenoxystyrene;
vinyl ketones such as vinyl methyl ketone, vinyl ethyl ketone, and vinyl phenyl ketone; and
vinyl sulfones such as divinyl sulfide, p-vinyl diphenyl sulfide, vinyl ethyl sulfide, vinyl ethyl sulfone, divinyl sulfone, and divinyl sulfoxide.
(9) Other vinyl monomers:
isocyanatoethyl (meth)acrylate and m-isopropenyl-α,α-dimethylbenzyl isocyanate.
(10) Vinyl monomers having fluorine:
4-fluorostyrene, 2,3,5,6-tetrafluorostyrene, pentafluorophenyl(meth)acrylate, pentafluorobenzyl(meth)acrylate, perfluorocyclohexyl(meth)acrylate, perfluorocyclohexyl methyl(meth)acrylate, 2,2,2-trifluoroethyl(meth)acrylate, 2,2,3,3-tetrafluoropropyl(meth)acrylate, 1H,1H,4H-hexafluorobutyl(meth)acrylate, 1H,1H,5H-octafluoropentyl(meth)acrylate, 1H,1H,7H-dodecafluoroheptyl(meth)acrylate, perfluorooctyl(meth)acrylate, 2-perfluorooctyl ethyl(meth)acrylate, heptadecafluorodecyl(meth)acrylate, trihydroperfluoroundecyl(meth)acrylate, perfluoronorbornyl methyl(meth)acrylate, 1H-perfluoroisobornyl(meth)acrylate, 2-(N-butyl perfluorooctane sulfonamide)ethyl(meth)acrylate, 2-(N-ethyl perfluorooctane sulfonamide)ethyl(meth)acrylate, and α-fluoro acrylic acid derivatives;
bis-hexafluoroisopropyl itaconate, bis-hexafluoroisopropyl maleate, bis-perfluorooctyl itaconate, bis-perfluorooctyl maleate, bis-trifluoroethyl itaconate, and bis-trifluoroethyl maleate; and
vinyl heptafluorobutyrate, vinyl perfluoroheptanoate, vinyl perfluorononanoate, and vinyl perfluorooctanoate.

Vinyl copolymers of 2 or more of the vinyl monomers (1) to (10) are usable as the vinyl resin. For example, styrene-(meth)acrylate copolymer, styrene-butadiene copolymer, (meth)acrylic acid-acrylate copolymer, styrene-acrylonitrile copolymer, styrene-maleic anhydride copolymer, styrene-(meth)acrylic acid copolymer, styrene-(meth)acrylic acid-divinylbenzene copolymer, and styrene-styrene sulfonic acid-(meth)acrylate copolymer are preferably used. To introduce fluorine to the particulate resin, 1 or more of the vinyl monomers (10) are copolymerized.

To form an aqueous dispersion of a particulate resin, resins used for the particulate resin are required to be not completely soluble in water at normal conditions. Therefore, when the resin is the vinyl copolymer described above, the ratio of hydrophobic monomer units to hydrophilic monomer units constituting the vinyl copolymer is preferably 10/90 or more, and more preferably 30/70 or more. When the ratio is less than 10/90, the vinyl copolymer may be water-soluble. As a result, the resultant toner may have a broad particle diameter distribution. Here, the hydrophilic monomer is defined as a monomer soluble in water at arbitrary ratio, and the hydrophobic monomer is defined as a monomer other than the hydrophilic monomer, i.e., a monomer basically immiscible with water.

Specific preferred methods for forming an aqueous dispersion of a particulate resin include the following methods of (a) to (h), for example.
(a) Subjecting a vinyl monomer to any one of suspension polymerization, emulsion polymerization, seed polymerization, and dispersion polymerization, so that an aqueous dispersion of a particulate resin is directly prepared.
(b) Dispersing a precursor (such as a monomer and an oligomer) of a polyaddition or polycondensation resin (such as a polyester resin, a polyurethane resin, and an epoxy resin) or a solvent solution thereof in an aqueous medium in the presence of a suitable dispersing agent, followed by heating or adding a curing agent, so that an aqueous dispersion of a particulate resin is prepared.
(c) Dissolving a suitable emulsifying agent in a precursor (such as a monomer and an oligomer) of a polyaddition or polycondensation resin (such as a polyester resin, a polyurethane resin, and an epoxy resin) or a solvent solution (preferably in liquid form, if not liquid, preferably liquefied by application of heat) thereof, and subsequently adding water thereto, so that an aqueous dispersion of a particulate resin is prepared by phase-inversion emulsification.
(d) Pulverizing a resin previously formed by a polymerization reaction (such as addition polymerization, ring-opening polymerization, polyaddition, addition condensation, condensation polymerization) using a mechanical rotational type pulverizer or a jet type pulverizer, classifying the pulverized particles to prepare a particulate resin, and dispersing the particulate resin in an aqueous medium in the presence of a suitable dispersing agent, so that an aqueous dispersion of the particulate resin is prepared.
(e) Spraying a resin solution, in which a resin previously formed by a polymerization reaction (such as addition polymerization, ring-opening polymerization, polyaddition, addition condensation, condensation polymerization) is dissolved in a solvent, into the air to prepare a particulate resin, and dispersing the particulate resin in an aqueous medium in the presence of a suitable dispersing agent, so that an aqueous dispersion of the particulate resin is prepared.
(f) Adding a poor solvent to a resin solution, in which a resin previously formed by a polymerization reaction (such as addition polymerization, ring-opening polymerization, polyaddition, addition condensation, condensation polymerization) is dissolved in a solvent, or cooling the resin solution which is previously dissolved in a solvent with application of heat, to precipitate a particulate resin, and dispersing the particulate resin in an aqueous medium in the presence of a suitable dispersing agent, so that an aqueous dispersion of the particulate resin is prepared.
(g) Dispersing a resin solution, in which a resin previously formed by a polymerization reaction (such as addition polymerization, ring-opening polymerization, polyaddition, addition condensation, condensation polymerization) is dissolved in a solvent, in an aqueous medium in the presence of a suitable dispersing agent, and removing the solvent by application of heat, reduction of pressure, and the like, so that an aqueous dispersion of a particulate resin is prepared.
(h) Dissolving a suitable emulsifying agent in a resin solution, in which a resin previously formed by a polymerization reaction (such as addition polymerization, ring-opening polymerization, polyaddition, addition condensation, condensation polymerization) is dissolved in a solvent, and subsequently adding water thereto, so that an aqueous dispersion of a particulate resin is prepared by phase-inversion emulsification.

Resins used for the particulate resin typically have an acid value of from 5 to 300 mgKOH/g, preferably from 20 to 250 mgKOH/g, and more preferably from 30 to 220 mgKOH/g. When the acid value is too small, dispersion stability of the particulate resin may deteriorate. When the acid value is too large, the surface of the resultant toner may be too hygroscopic, resulting in poor environmental charge stability.

The particulate resin typically has a smaller particle diameter than the resultant toner. To obtain uniform-sized toner particles, the ratio of the volume average particle diameter of the particulate resin to that of the toner is preferably from 0.001 to 0.3. When the ratio is too large, the particulate resin may ineffectively adsorb to the surface of liquid droplets of the toner constituent liquid in the aqueous medium, and therefore the resultant toner may have a broad particle diameter distribution. The volume average particle diameter of the particulate resin is controllable with satisfying the above ratio, so as to obtain a toner having a desired particle diameter. For example, to obtain a toner having a volume average particle diameter of 5 μm, the volume average particle diameter of the particulate resin is preferably from 0.0025 to 1.5 μm, and more preferably from 0.005 to 1.0 μm; and to obtain a toner having a volume average particle diameter of 10 μm, the volume average particle diameter of the particulate resin is preferably from 0.005 to 3.0 μm, and more preferably from 0.05 to 2.0 μm. The volume average particle diameter can be measured using particle size analyzers such as UPA-150 (from Nikkiso Co., Ltd.), LA-920 (from Horiba, Ltd.), and MULTISIZER II (from Beckman Coulter K.K.).

As described above, the toner of the present invention is obtainable by dispersing the toner constituent liquid comprising a colorant, the polyester (I), and the isocyanate-modified polyester (A) together with the amine (B) in an aqueous medium, and subjecting the isocyanate-modified polyester (A) and the amine (B) to an elongation and/or cross-linking reaction to form an urea-modified polyester. To form a stable aqueous dispersion containing the isocyanate-modified polyester (A), toner constituents including the isocyanate-modified polyester (A) may be previously dissolved or dispersed in an organic solvent, and the toner constituent liquid thus prepared may be dispersed in an aqueous medium upon application of shearing force. One possible method to prepare the toner constituent liquid may include dissolving or dispersing the isocyanate-modified polyester (A) in an organic solvent first, and mixing with other toner constituents such as a colorant, a colorant master batch, a release agent, a charge controlling agent, and the polyester (I) at a time the isocyanate-modified polyester (A) is dispersed in an aqueous medium. Alternatively, the isocyanate-modified polyester (A) and other toner constituents may be previously mixed, so that the mixture is dissolved or dispersed in an organic solvent at once. The latter is more preferable. The other toner constituents such as a release agent and a charge controlling agent do not necessarily need to be added to the toner constituent liquid before being dispersed in an aqueous medium. These agents may be externally added to the resultant particles.

Any known dispersing machines such as low-speed shearing type, high-speed shearing type, friction type, high pressure jet type, and ultrasonic type can be used for the dispersion. In order to prepare a dispersion including particles having an average particle diameter of from 2 to 20 Am, a high-speed shearing type dispersing machine is preferably used. When high-speed shearing type dispersing machines are used, the rotation speed of rotors is typically from 1,000 to 30,000 rpm and preferably from 5,000 to 20,000 rpm, but not limited thereto. The dispersing time is typically from 0.1 to 5 minutes in batch type dispersing machines, but not limited thereto. The temperature in the dispersing process is typically from 0 to 150° C. (under pressure), and preferably from 40 to 98° C. The higher the temperature, the lower the viscosity of the dispersion containing the isocyanate-modified polyester (A), resulting in easy formation of dispersion.

The amount of the aqueous medium is typically from 50 to 2000 parts by weight, and preferably from 100 to 1000 parts by weight, based on 100 parts by weight of solid components included in the toner constituent liquid. When the amount is too small, the toner constituent liquid may be unevenly dispersed, resulting in production of undesired-sized toner particles. When the amount is too large, manufacturing cost may increase.

Dispersing agents may be optionally used when the toner constituent liquid is dispersed or emulsified in an aqueous medium, so as to improve stability of the dispersion and to narrow the particle diameter distribution of the resultant toner.

Specific examples of usable dispersing agents include, but are not limited to, anionic surfactants such as alkylbenzene sulfonates, α-olefin sulfonates, and phosphates; cationic surfactants such as amine salts (e.g., alkylamine salts, amino alcohol aliphatic acid derivatives, polyamine aliphatic acid derivatives, imidazoline) and quaternary ammonium salts (e.g., alkyl trimethyl ammonium salts, dialkyl dimethyl ammonium salts, alkyl dimethyl benzyl ammonium salts, pyridinium salts, alkyl isoquinolinium salts, benzethonium chloride); nonionic surfactants such as aliphatic amide derivatives and polyvalent alcohol derivatives; and ampholytic surfactants such as alanine, dodecyl di(aminoethyl) glycine, di(octyl aminoethyl) glycine, and alkyl-N,N-dimethyl ammonium betaine.

Surfactants having a fluoroalkyl group are effective even in small amounts. Specific preferred examples of usable anionic surfactants having a fluoroalkyl group include, but are not limited to, fluoroalkyl carboxylic acids having 2 to 10 carbon atoms and metal salts thereof, perfluorooctane sulfonyl glutamic acid disodium, 3-[ω-fluoroalkyl(C6-C11)oxy]-1-alkyl(C3-C4) sulfonic acid sodium, 3-[ω-fluoroalkanoyl(C6-C8)-N-ethylamino]-1-propane sulfonic acid sodium, fluoroalkyl(C11-C20) carboxylic acids and metal salts thereof, perfluoroalkyl(C7-C13) carboxylic acids and metal salts thereof, perfluoroalkyl(C4-C12) sulfonic acids and metal salts thereof, perfluorooctane sulfonic acid dimethanol amide, N-propyl-N-(2-hydroxyethyl) perfluorooctane sulfonamide, perfluoroalkyl(C6-C10) sulfonamide propyl trimethyl ammonium salts, perfluoroalkyl(C6-C10)-N-ethyl sulfonyl glycine salts, and monoperfluoroalkyl(C6-C16) ethyl phosphates.

Specific examples of usable commercially available anionic surfactants having a fluoroalkyl group include, but are not limited to, SARFRON® S-111, S-112 and S-113 (manufactured by Asahi Glass Co., Ltd.); FLUORAD® FC-93, FC-95, FC-98 and FC-129 (manufactured by Sumitomo 3M Ltd.); UNIDYNE® DS-101 and DS-102 (manufactured by Daikin Industries, Ltd.); MEGAFACE® F-110, F-120, F-113, F-191, F-812 and F-833 (manufactured by Dainippon Ink and Chemicals, Inc.); ECTOP® EF-102, 103, 104, 105, 112, 123A, 123B, 306A, 501, 201 and 204 (manufactured by Tochem Products Co., Ltd.); and FUTARGENT® F-100 and F-150 (manufactured by Neos).

Specific preferred examples of usable cationic surfactants having a fluoroalkyl group include, but are not limited to, aliphatic primary, secondary, and tertiary amine acids having a fluoroalkyl group, aliphatic tertiary ammonium salts such as perfluoroalkyl(C6-C10) sulfonamide propyl trimethyl ammonium salts, benzalkonium salts, benzethonium chloride, pyridinium salts, and imidazolinium salts.

Specific examples of usable commercially available cationic surfactants include, but are not limited to, SARFRON® S-121 (manufactured by Asahi Glass Co., Ltd.); FLUORAD® FC-135 (manufactured by Sumitomo 3M Ltd.); UNIDYNE® DS-202 (manufactured by Daikin Industries, Ltd.); MEGAFACE® F-150 and F-824 (manufactured by Dainippon Ink and Chemicals, Inc.); ECTOP® EF-132 (manufactured by Tohchem Products Co., Ltd.); and FUTARGENT® F-300 (manufactured by Neos).

Water-insoluble inorganic dispersants such as tricalcium phosphate, calcium carbonate, titanium oxide, colloidal silica, and hydroxyapatite can also be used.

When the dispersing agent is a compound soluble in acids or bases, such as calcium phosphate, the calcium phosphate on the surface of the resultant toner may be removed by being dissolved by an acid such as hydrochloric acid, and then washed with water. Alternatively, some dispersing agents can be removed by decomposition by enzymes.

Of course, the dispersing agent may remain on the surface of the resultant toner, however, it is preferable to remove from the viewpoint of chargeability of the resultant toner.

The reaction time for the elongation and/or cross-linking is typically from 10 minutes to 40 hours, and preferably from 2 to 24 hours, but it depends on reactivity between the isocyanate-modified polyester (A) and the amine (B). The reaction temperature is typically from 0 to 150° C., and preferably from 40 to 98° C. Any known catalyst such as dibutyltin laurate and dioctyltin laurate can be used, if desired.

To remove organic solvents from the dispersion, one possible method includes gradually heating the dispersion so that the organic solvents contained in liquid droplets completely evaporate. Alternatively, another method includes spraying the dispersion into dry atmosphere so that water-insoluble organic solvents are completely removed while water-miscible organic solvents evaporate. Specific examples of the dry atmosphere include gases such as air, nitrogen gas, carbon dioxide gas, and combustion gas, which are heated, preferably heated to a temperature equal to or greater than the boiling point of a solvent having the highest boiling point. The resultant particles are then dried using a spray drier, a belt drier, or a rotary kiln for a short time.

When the resultant particles have a broad particle diameter distribution, the resultant particles may be subjected to classification in the dispersion, to have a desired particle diameter distribution.

For example, ultrafine particles can be removed by cyclone, decanter, centrifugal separation, and the like. Of course, the classification can be performed after the resultant particles are washed and dried. However, the classification is preferably performed in liquids, in terms of efficiency.

The dispersing agent is preferably removed from the dispersion at a time of classification.

Fine particles of release agents, charge controlling agents, fluidizers, colorants, and the like, may be mixed with the dried resultant toner particles. Alternatively, these fine particles may be fixed or fused on the surfaces of the toner particles by application of mechanical impact, so that the fine particles do not release therefrom.

Mechanical impact is applied to the particles by the following methods, for example: rotating agitation blade at a high speed; or putting the particles in a high-speed gas flow so that the particles or the combined particles collide with a collision plate. Specific examples of usable mechanical impact applicators include, but are not limited to, ONG MILL (manufactured by Hosokawa Micron Co., Ltd.), modified I TYPE MILL in which the pressure of air used for pulverizing is reduced (manufactured by Nippon Pneumatic Mfg. Co., Ltd.), HYBRIDIZATION SYSTEM (manufactured by Nara Machine Co., Ltd.), KRYPTON SYSTEM (manufactured by Kawasaki Heavy Industries, Ltd.), and automatic mortars.

Specific examples of colorants for use in the toner of the present invention include any known dyes and pigments such as carbon black, Nigrosine dyes, black iron oxide, NAPHTHOL YELLOW S, HANSA YELLOW (10G, 5G and G), Cadmium Yellow, yellow iron oxide, loess, chrome yellow, Titan Yellow, polyazo yellow, Oil Yellow, HANSA YELLOW (GR, A, RN and R), Pigment Yellow L, BENZIDINE YELLOW (G and GR), PERMANENT YELLOW (NCG), VULCAN FAST YELLOW (5G and R), Tartrazine Lake, Quinoline Yellow Lake, ANTHRAZANE YELLOW BGL, isoindolinone yellow, red iron oxide, red lead, orange lead, cadmium red, cadmium mercury red, antimony orange, Permanent Red 4R, Para Red, Fire Red, p-chloro-o-nitroaniline red, Lithol Fast Scarlet G, Brilliant Fast Scarlet, Brilliant Carmine BS, PERMANENT RED (F2R, F4R, FRL, FRLL and F4RH), Fast Scarlet VD, VULCAN FAST RUBINE B, Brilliant Scarlet G, LITHOL RUBINE GX, Permanent Red F5R, Brilliant Carmine 6B, Pigment Scarlet 3B, Bordeaux 5B, Toluidine Maroon, PERMANENT BORDEAUX F2K, HELIO BORDEAUX BL, Bordeaux 10B, BON MAROON LIGHT, BON MAROON MEDIUM, Eosin Lake, Rhodamine Lake B, Rhodamine Lake Y, Alizarine Lake, Thioindigo Red B, Thioindigo Maroon, Oil Red, Quinacridone Red, Pyrazolone Red, polyazo red, Chrome Vermilion, Benzidine Orange, perynone orange, Oil Orange, cobalt blue, cerulean blue, Alkali Blue Lake, Peacock Blue Lake, Victoria Blue Lake, metal-free Phthalocyanine Blue, Phthalocyanine Blue, Fast Sky Blue, INDANTHRENE BLUE (RS and BC), Indigo, ultramarine, Prussian blue, Anthraquinone Blue, Fast Violet B, Methyl Violet Lake, cobalt violet, manganese violet, dioxane violet, Anthraquinone Violet, Chrome Green, zinc green, chromium oxide, viridian, emerald green, Pigment Green B, Naphthol Green B, Green Gold, Acid Green Lake, Malachite Green Lake, Phthalocyanine Green, Anthraquinone Green, titanium oxide, zinc oxide, and lithopone. These materials can be used alone or in combination. The toner typically includes the colorant in an amount of from 1 to 15% by weight, and preferably from 3 to 10% by weight.

The colorant for use in the present invention can be combined with a resin to be used as a master batch. Specific examples of the resin for use in the master batch include, but are not limited to, polyester, polymers of styrenes or substitutions thereof (e.g., polystyrene, poly-p-chlorostyrene, polyvinyl toluene), styrene copolymers (e.g., styrene-p-chlorostyrene copolymer, styrene-propylene copolymer, styrene-vinyltoluene copolymer, styrene-vinylnaphthalene copolymer, styrene-methyl acrylate copolymer, styrene-ethyl acrylate copolymer, styrene-butyl acrylate copolymer, styrene-octyl acrylate copolymer, styrene-methyl methacrylate copolymer, styrene-ethyl methacrylate copolymer, styrene-butyl methacrylate copolymer, styrene-methyl α-chloro methacrylate copolymer, styrene-acrylonitrile copolymer, styrene-vinyl methyl ketone copolymer, styrene-butadiene copolymer, styrene-isoprene copolymer, styrene-acrylonitrile-indene copolymer, styrene-maleic acid copolymer, styrene-maleic acid ester copolymer), polymethyl methacrylate, polybutyl methacrylate, polyvinyl chloride, polyvinyl acetate, polyethylene, polypropylene, epoxy resins, epoxy polyol resins, polyurethane, polyamide, polyvinyl butyral, polyacrylic acid resins, rosin, modified rosin, terpene resins, aliphatic hydrocarbon resins, alicyclic hydrocarbon resins, aromatic petroleum resins, chlorinated paraffin, and paraffin wax. These resins can be used alone or in combination.

The master batches can be prepared by mixing one or more of the resins as mentioned above and the colorant as mentioned above and kneading the mixture while applying a high shearing force thereto. In this case, an organic solvent can be added to increase the interaction between the colorant and the resin. In addition, a flushing method in which an aqueous paste including a colorant and water is mixed with a resin dissolved in an organic solvent and kneaded so that the colorant is transferred to the resin side (i.e., the oil phase), and then the organic solvent (and water, if desired) is removed, can be preferably used because the resultant wet cake can be used as it is without being dried. When performing the mixing and kneading process, dispersing devices capable of applying a high shearing force such as three roll mills can be preferably used.

The toner of the present invention preferably includes a release agent. Specific examples of usable release agents include, but are not limited to, polyolefin waxes (e.g., polyethylene wax, polypropylene wax), long-chain hydrocarbons (e.g., paraffin wax, SASOL wax), and waxes having a carbonyl group.

Specific examples of usable waxes having a carbonyl group include, but are not limited to, polyalkanoic acid esters (e.g., carnauba wax, montan wax, trimethylolpropane tribehenate, pentaerythritol tetrabehenate, pentaerythritol diacetate dibehenate, glycerin tribehenate, 1,18-octadecanediol distearate), polyalkanol esters (e.g., tristearyl trimellitate, distearyl maleate), polyalkanoic acid amides (e.g., ethylenediamine dibehenylamide), polyalkylamides (e.g., trimellitic acid tristearylamide), and dialkyl ketones (e.g., distearyl ketone). Among these waxes having a carbonyl group, polyalkanoic acid esters are preferably used.

Among the above waxes, waxes having a low polarity are preferably used. For example, hydrocarbon waxes such as polyethylene wax, polypropylene wax, paraffin wax, SASOL wax, microcrystalline wax, Fisher-Tropsch wax, are preferably used for the present invention.

The toner preferably includes the wax in an amount of from 2 to 5% by weight. When the amount is too small, the wax may not express releasing property, and therefore the resultant toner may have insufficient hot offset resistance. When the amount is too large, the wax may bleed out from the toner when agitated in the developing device, because the toner easily melts at low temperatures and is adversely affected by thermal and mechanical energies. Consequently, the wax may contaminate the toner control member and photoreceptor, resulting in image noise. When such a toner forms an image on an OHP sheet, the wax may spread beyond the image region, resulting in image noise in a projected image.

The wax preferably has an endothermic peak in a temperature range of from 60 to 90° C., and more preferably from 65 to 80° C., when heated by differential scanning calorimetry. When the endothermic peak is observed at too low a temperature, the resultant toner may have poor fluidity and thermostable preservability. When the endothermic peak is observed at too high a temperature, the resultant toner may have poor fixability.

In addition, the endothermic peak preferably has a half bandwidth of 8° C. or less, and more preferably 6° C. or less. When the half bandwidth is too large, i.e., the endothermic peak is too broad, the resultant toner may have poor fluidity and thermostable preservability.

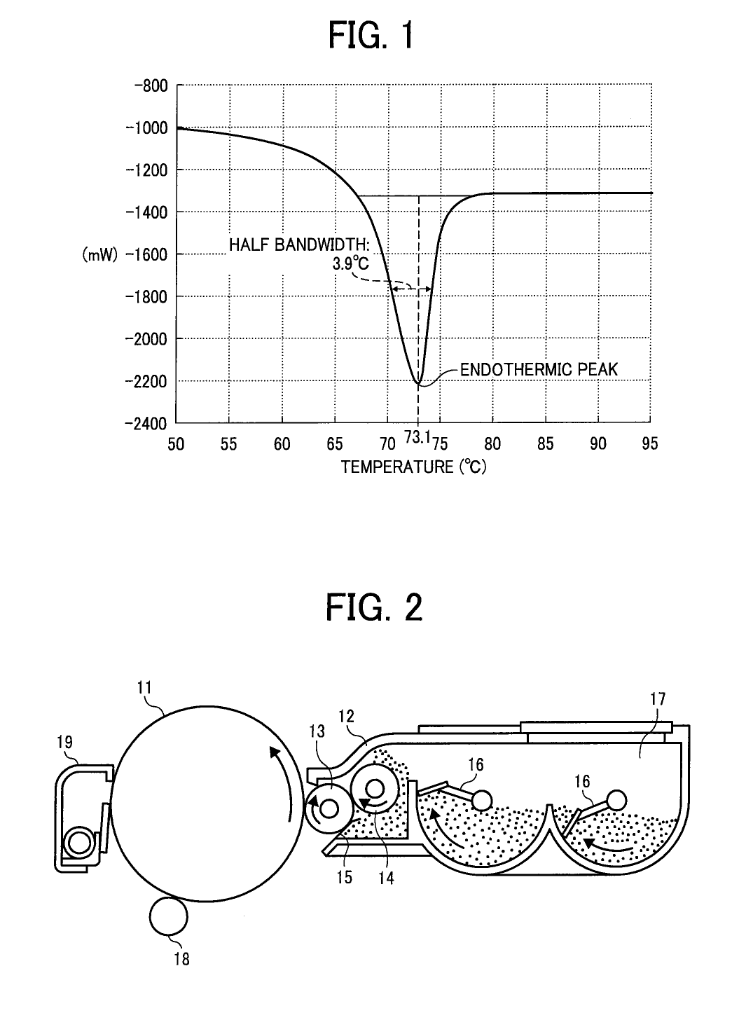

FIG. 1 is a graph showing an endothermic curve of a paraffin wax used in Examples, obtained by a differential scanning calorimeter. As shown therein, this paraffin wax has an endothermic peak at 73.1° C., and the half bandwidth thereof is 3.9° C.

The toner of the present invention may include a charge controlling agent, if desired. Specific examples of usable charge controlling agent include, but are not limited to, Nigrosine dyes, triphenylmethane dyes, metal complex dyes including chromium, chelate compounds of molybdic acid, Rhodamine dyes, alkoxyamines, quaternary ammonium salts (including fluorine-modified quaternary ammonium salts), alkylamides, phosphor and compounds including phosphor, tungsten and compounds including tungsten, fluorine-containing surfactants, metal salts of salicylic acid, and metal salts of salicylic acid derivatives. These materials can be used alone or in combination.

Specific examples of commercially available charge controlling agents include, but are not limited to, BONTRON® N-03 (Nigrosine dye), BONTRON® P-51 (quaternary ammonium salt), BONTRON® S-34 (metal-containing azo dye), BONTRON® E-82 (metal complex of oxynaphthoic acid), BONTRON® E-84 (metal complex of salicylic acid), and BONTRON® E-89 (phenolic condensation product), which are manufactured by Orient Chemical Industries Co., Ltd.; TP-302 and TP-415 (molybdenum complex of quaternary ammonium salt), which are manufactured by Hodogaya Chemical Co., Ltd.; COPY CHARGE® PSY VP2038 (quaternary ammonium salt), COPY BLUE® PR (triphenyl methane derivative), COPY CHARGE® NEG VP2036 and COPY CHARGE® NX VP434 (quaternary ammonium salt), which are manufactured by Hoechst AG; LRA-901, and LR-147 (boron complex), which are manufactured by Japan Carlit Co., Ltd.; copper phthalocyanine, perylene, quinacridone, azo pigments, and polymers having a functional group such as sulfonate group, carboxyl group, and a quaternary ammonium group.

To improve fluidity, developability, and chargeability, fine particles of inorganic materials and/or polymers may be externally added to the toner of the present invention.

Fine particles of inorganic materials preferably have a primary particle diameter of from 5 nm to 2 μm, and more preferably from 5 to 500 nm; and a specific surface area based on BET method of from 20 to 500 m²/g. The toner preferably includes fine particles of inorganic materials in an amount of from 0.01 to 5% by weight, and more preferably from 0.01 to 2.0% by weight. Specific examples of usable inorganic materials include, but are not limited to, silica, alumina, titanium oxide, barium titanate, magnesium titanate, calcium titanate, strontium titanate, zinc oxide, tin oxide, quartz sand, clay, mica, sand-lime, diatom earth, chromium oxide, cerium oxide, red iron oxide, antimony trioxide, magnesium oxide, zirconium oxide, barium sulfate, barium carbonate, calcium carbonate, silicon carbide, and silicon nitride.

Specific examples of usable polymers include, but are not limited to, fine particles of polymers manufactured by a soap-free emulsion polymerization, a suspension polymerization, or a dispersion polymerization, such as polystyrene; copolymers of methacrylates and acrylates; polycondensation polymers such as silicone, benzoguanamine, and nylon; and thermosetting resins.

The above-described fine particles are preferably surface-treated to improve hydrophobicity, so that the resultant toner has reliable fluidity and chargeability even in highly humid conditions. Specific examples of usable surface treatment agents include, but are not limited to, silane coupling agents, silylation agents, silane coupling agents having fluorinated alkyl group, organic titanate coupling agents, aluminum coupling agents, silicone oils, and modified silicone oils.

A cleanability improving agent, to remove toner particles remaining on photoreceptor or primary intermediate transfer member, may be added to the toner, if desired. Specific examples of usable cleanability improving agents include, but are not limited to, metal salts of aliphatic acids such as zinc stearate and calcium stearate; fine particles of polymers such as polymethyl methacrylate and polystyrene, which are manufactured by soap-free emulsion polymerization. The fine particles of polymers preferably have a narrow particle diameter distribution and a volume average particle diameter of from 0.01 to 1 μm.

The toner of the present invention can be used for a process cartridge. The process cartridge integrally combines a plurality of members, such as a photoreceptor, a charger, a developing device, and a cleaning device. The process cartridge is detachable attachable to image forming apparatuses such as copiers and printers.

FIG. 2 is a schematic view illustrating an embodiment of a process cartridge of the present invention. The process cartridge illustrated in FIG. 2 includes a photoreceptor 11, a charger 18, a developing device 12, and a cleaning device 19.

First, the photoreceptor 11 is rotated at a predetermined speed. The photoreceptor 11, which is rotating, is evenly charged by the charger 18 to have a predetermined positive or negative potential, and subsequently irradiated with a light beam emitted from a slit irradiator or a laser beam scanning irradiator, thereby sequentially forming an electrostatic latent image on a surface of the photoreceptor 11. The electrostatic latent image is then developed with a toner in the developing device 12 to form a toner image, and the toner image is sequentially transferred onto a transfer medium, which is fed from a paper feeding part in synchronization with the rotation of the photoreceptor 11. The transfer medium having the toner image thereon is separated from the photoreceptor and introduced to a fixing device so that the toner image is fixed on the transfer medium. Thus, a copy or print is discharged from an image bearing member. Toner particles which are not transferred but remain on the surface of the photoreceptor 11 are removed by the cleaning device 19, and electric potential of the surface of the photoreceptor 11 is removed to prepare for a next image forming operation.

As illustrated in FIG. 2, the developing device 12 includes a toner containing chamber 17, a toner conveyance member 13, a toner supply member 14 configured to supply a toner contained in the toner containing chamber 17 to the surface of the toner conveyance member 13, a toner control member 15 configured to control the thickness of a toner layer formed on the toner conveyance member 13, and toner agitation paddles 16.

Having generally described this invention, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

### Synthesis of Polyester (I)

In a reaction vessel equipped with a condenser, a stirrer, and a nitrogen inlet pipe, 229 parts of ethylene oxide 2 mol adduct of bisphenol A, 529 parts of propylene oxide 3 mol adduct of bisphenol A, 208 parts of terephthalic acid, 46 parts of adipic acid, and 2 parts of dibutyltin oxide are contained, and subjected to a reaction for 8 hours at 230° C. at normal pressures. Subsequently, the mixture is subjected to a reaction for 5 hours at a reduced pressure of from 10 to 15 mmHg. Further, 44 parts of trimellitic anhydride are added thereto, and the mixture is subjected to a reaction for 2 hours at 180° C. at normal pressures. Thus, an unmodified polyester (I) is prepared.

The polyester (I) has a number average molecular weight of 2500, a weight average molecular weight of 6700, a glass transition temperature of 43° C., and an acid value of 25 mgKOH/g.

### Synthesis of Isocyanate-Modified Polyester (1)

In a reaction vessel equipped with a condenser, a stirrer, and a nitrogen inlet pipe, 670 parts of ethylene oxide 2 mol adduct of bisphenol A, 75 parts of propylene oxide 2 mol adduct of bisphenol A, 283 parts of terephthalic acid, 29 parts of trimellitic anhydride, and 2 parts of dibutyltin oxide are contained, and subjected to a reaction for 8 hours at 230° C. at normal pressures. Subsequently, the mixture is subjected to a reaction for 6 hours at a reduced pressure of from 10 to 15 mmHg. Thus, an intermediate polyester (1) is prepared.

The intermediate polyester (1) has a number average molecular weight of 2700, a weight average molecular weight of 11700, an acid value of 0.5 mgKOH/g, a hydroxyl value of 57 mgKOH/g, and an f value of 2.74.

Next, in a reaction vessel equipped with a condenser, a stirrer, and a nitrogen inlet pipe, 400 parts of the intermediate polyester (1), 96 parts of isophorone diisocyanate, and 500 parts of ethyl acetate are contained, and subjected to a reaction for 5 hours at 100° C. Thus, an isocyanate-modified polyester (1) is prepared.

### Synthesis of Isocyanate-Modified Polyester (2)

In a reaction vessel equipped with a condenser, a stirrer, and a nitrogen inlet pipe, 660 parts of ethylene oxide 2 mol adduct of bisphenol A, 72 parts of propylene oxide 2 mol adduct of bisphenol A, 300 parts of terephthalic acid, 24 parts of trimellitic anhydride, and 2 parts of dibutyltin oxide are contained, and subjected to a reaction for 9 hours at 230° C. at normal pressures. Subsequently, the mixture is subjected to a reaction for 7 hours at a reduced pressure of from 10 to 15 mmHg. Thus, an intermediate polyester (2) is prepared.

The intermediate polyester (2) has a number average molecular weight of 3900, a weight average molecular weight of 14400, an acid value of 0.6 mgKOH/g, a hydroxyl value of 34 mgKOH/g, and an f value of 2.36.

Next, in a reaction vessel equipped with a condenser, a stirrer, and a nitrogen inlet pipe, 430 parts of the intermediate polyester (2), 65 parts of isophorone diisocyanate, and 500 parts of ethyl acetate are contained, and subjected to a reaction for 5 hours at 100° C. Thus, an isocyanate-modified polyester (2) is prepared.

### Synthesis of Isocyanate-Modified Polyester (3)

In a reaction vessel equipped with a condenser, a stirrer, and a nitrogen inlet pipe, 660 parts of ethylene oxide 2 mol adduct of bisphenol A, 72 parts of propylene oxide 2 mol adduct of bisphenol A, 290 parts of terephthalic acid, 33 parts of trimellitic anhydride, and 2 parts of dibutyltin oxide are contained, and subjected to a reaction for 9 hours at 230° C. at normal pressures. Subsequently, the mixture is subjected to a reaction for 7 hours at a reduced pressure of from 10 to 15 mmHg. Thus, an intermediate polyester (3) is prepared.

The intermediate polyester (3) has a number average molecular weight of 3800, a weight average molecular weight of 15000, an acid value of 0.5 mgKOH/g, a hydroxyl value of 51 mgKOH/g, and an f value of 3.45.

Next, in a reaction vessel equipped with a condenser, a stirrer, and a nitrogen inlet pipe, 410 parts of the intermediate polyester (3), 88 parts of isophorone diisocyanate, and 500 parts of ethyl acetate are contained, and subjected to a reaction for 5 hours at 100° C. Thus, an isocyanate-modified polyester (3) is prepared.

### Synthesis of Isocyanate-Modified Polyester (4)

In a reaction vessel equipped with a condenser, a stirrer, and a nitrogen inlet pipe, 682 parts of ethylene oxide 2 mol adduct of bisphenol A, 81 parts of propylene oxide 2 mol adduct of bisphenol A, 279 parts of terephthalic acid, 26 parts of trimellitic anhydride, and 2 parts of dibutyltin oxide are contained, and subjected to a reaction for 8 hours at 230° C. at normal pressures. Subsequently, the mixture is subjected to a reaction for 5 hours at a reduced pressure of from 10 to 15 mmHg. Thus, an intermediate polyester (4) is prepared.

The intermediate polyester (4) has a number average molecular weight of 1800, a weight average molecular weight of 8200, an acid value of 0.6 mgKOH/g, a hydroxyl value of 90 mgKOH/g, and an f value of 2.89.

Next, in a reaction vessel equipped with a condenser, a stirrer, and a nitrogen inlet pipe, 365 parts of the intermediate polyester (4), 135 parts of isophorone diisocyanate, and 500 parts of ethyl acetate are contained, and subjected to a reaction for 5 hours at 100° C. Thus, an isocyanate-modified polyester (4) is prepared.

### Synthesis of Isocyanate-Modified Polyester (5)

In a reaction vessel equipped with a condenser, a stirrer, and a nitrogen inlet pipe, 682 parts of ethylene oxide 2 mol adduct of bisphenol A, 81 parts of propylene oxide 2 mol adduct of bisphenol A, 281 parts of terephthalic acid, 24 parts of trimellitic anhydride, and 2 parts of dibutyltin oxide are contained, and subjected to a reaction for 8 hours at 230° C. at normal pressures. Subsequently, the mixture is subjected to a reaction for 5 hours at a reduced pressure of from 10 to 15 mmHg. Thus, an intermediate polyester (5) is prepared.

The intermediate polyester (5) has a number average molecular weight of 1600, a weight average molecular weight of 7900, an acid value of 0.6 mgKOH/g, a hydroxyl value of 82 mgKOH/g, and an f value of 2.34.

Next, in a reaction vessel equipped with a condenser, a stirrer, and a nitrogen inlet pipe, 380 parts of the intermediate polyester (5), 130 parts of isophorone diisocyanate, and 500 parts of ethyl acetate are contained, and subjected to a reaction for 5 hours at 100° C. Thus, an isocyanate-modified polyester (5) is prepared.

### Synthesis of Isocyanate-Modified Polyester (6)

In a reaction vessel equipped with a condenser, a stirrer, and a nitrogen inlet pipe, 682 parts of ethylene oxide 2 mol adduct of bisphenol A, 81 parts of propylene oxide 2 mol adduct of bisphenol A, 283 parts of terephthalic acid, 22 parts of trimellitic anhydride, and 2 parts of dibutyltin oxide are contained, and subjected to a reaction for 8 hours at 230° C. at normal pressures. Subsequently, the mixture is subjected to a reaction for 5 hours at a reduced pressure of from 10 to 15 mmHg. Thus, an intermediate polyester (6) is prepared.

The intermediate polyester (6) has a number average molecular weight of 2200, a weight average molecular weight of 9700, a glass transition temperature of 54° C., an acid value of 0.5 mgKOH/g, a hydroxyl value of 52 mgKOH/g, and an f value of 2.04.

Next, in a reaction vessel equipped with a condenser, a stirrer, and a nitrogen inlet pipe, 410 parts of the intermediate polyester (6), 89 parts of isophorone diisocyanate, and 500 parts of ethyl acetate are contained, and subjected to a reaction for 5 hours at 100° C. Thus, an isocyanate-modified polyester (6) is prepared.

### Synthesis of Isocyanate-Modified Polyester (7)

In a reaction vessel equipped with a condenser, a stirrer, and a nitrogen inlet pipe, 696 parts of ethylene oxide 2 mol adduct of bisphenol A, 86 parts of propylene oxide 2 mol adduct of bisphenol A, 281 parts of terephthalic acid, 24 parts of trimellitic anhydride, and 2 parts of dibutyltin oxide are contained, and subjected to a reaction for 7 hours at 230° C. at normal pressures. Subsequently, the mixture is subjected to a reaction for 5 hours at a reduced pressure of from 10 to 15 mmHg. Thus, an intermediate polyester (7) is prepared.

The intermediate polyester (7) has a number average molecular weight of 1400, a weight average molecular weight of 6800, an acid value of 0.7 mgKOH/g, a hydroxyl value of 94 mgKOH/g, and an f value of 2.35.

Next, in a reaction vessel equipped with a condenser, a stirrer, and a nitrogen inlet pipe, 360 parts of the intermediate polyester (7), 140 parts of isophorone diisocyanate, and 500 parts of ethyl acetate are contained, and subjected to a reaction for 6 hours at 100° C. Thus, an isocyanate-modified polyester (7) is prepared.

### Synthesis of Isocyanate-Modified Polyester (8)

In a reaction vessel equipped with a condenser, a stirrer, and a nitrogen inlet pipe, 640 parts of ethylene oxide 2 mol adduct of bisphenol A, 81 parts of propylene oxide 2 mol adduct of bisphenol A, 310 parts of terephthalic acid, 37 parts of trimellitic anhydride, and 2 parts of dibutyltin oxide are contained, and subjected to a reaction for 10 hours at 230° C. at normal pressures. Subsequently, the mixture is subjected to a reaction for 5 hours at a reduced pressure of from 10 to 15 mmHg. Thus, an intermediate polyester (8) is prepared.

The intermediate polyester (8) has a number average molecular weight of 4300, a weight average molecular weight of 20100, an acid value of 0.4 mgKOH/g, a hydroxyl value of 39 mgKOH/g, and an f value of 2.99.

Next, in a reaction vessel equipped with a condenser, a stirrer, and a nitrogen inlet pipe, 430 parts of the intermediate polyester (8), 70 parts of isophorone diisocyanate, and 500 parts of ethyl acetate are contained, and subjected to a reaction for 6 hours at 100° C. Thus, an isocyanate-modified polyester (8) is prepared.

### Synthesis of Isocyanate-Modified Polyester (9)

In a reaction vessel equipped with a condenser, a stirrer, and a nitrogen inlet pipe, 670 parts of ethylene oxide 2 mol adduct of bisphenol A, 82 parts of propylene oxide 2 mol adduct of bisphenol A, 266 parts of terephthalic acid, 24 parts of trimellitic anhydride, and 2 parts of dibutyltin oxide are contained, and subjected to a reaction for 8 hours at 230° C. at normal pressures. Subsequently, the mixture is subjected to a reaction for 5 hours at a reduced pressure of from 10 to 15 mmHg. Thus, an intermediate polyester (9) is prepared.

The intermediate polyester (9) has a number average molecular weight of 2600, a weight average molecular weight of 11100, an acid value of 0.4 mgKOH/g, a hydroxyl value of 78 mgKOH/g, and an f value of 3.61.

Next, in a reaction vessel equipped with a condenser, a stirrer, and a nitrogen inlet pipe, 380 parts of the intermediate polyester (9), 120 parts of isophorone diisocyanate, and 500 parts of ethyl acetate are contained, and subjected to a reaction for 6 hours at 100° C. Thus, an isocyanate-modified polyester (9) is prepared.

### Preparation of Master Batch

The following components are mixed using a HENSCHEL MIXER: 40 parts of a carbon black (REGAL® 400R from Cabot Corporation), 60 parts of a polyester resin (RS-301 from Sanyo Chemical Industries, Ltd., having an acid value of 10, Mw of 20000, and Tg of 64° C.), and 30 parts of water. Thus, a mixture in which water is immersed into pigment aggregations is prepared. The mixture is kneaded for 45 minutes using a double-roll mill, the surface temperature of which is set to 130° C., and the kneaded mixture is pulverized into particles having a particular diameter of about 1 mm. Thus, a master batch (1) is prepared.

### Example 1

### (Preparation of Colorant-Wax Dispersion)

In a reaction vessel equipped with a stirrer and a thermometer, 545 parts of the polyester (I), 85 parts of a paraffin wax (a DSC curve of which has an endothermic peak at 73.1° C., and the half bandwidth thereof is 3.9° C.), and 1450 parts of ethyl acetate are contained, and heated to 80° C. while being agitated. The mixture is kept at 80° C. for 5 hours, and cooled to 30° C. over a period of 1 hour. Further, 500 parts of the master batch (1) and 100 parts of ethyl acetate are added thereto and mixed for 1 hour. Thus, a raw material liquid (1) is prepared.

Next, 1500 parts of the raw material liquid (1) are contained in another vessel, and subjected to a dispersion treatment using a bead mill (ULTRAVISCOMILL (trademark) from Aimex Co., Ltd.). The dispersing conditions are as follows.

Liquid feeding speed: 1 kg/hour

Peripheral speed of disc: 6 m/sec

Dispersion media: zirconia beads with a diameter of 0.5 mm

Filling factor of beads: 80% by volume

Repeat number of dispersing operation: 3 times (3 passes)

Further, 425 parts of the polyester (I) and 230 parts of ethyl acetate are added thereto, and the mixture is subjected to the same dispersion treatment described above except for reducing the repeat number of dispersing operation to 1 time (1 pass). Thus, a colorant-wax dispersion (1) is prepared. Ethyl acetate is added to the colorant-wax dispersion (1) so that the concentration of solid components becomes 50% at 130° C. after 30 minutes.

### (Preparation of Aqueous Medium)

To prepare an aqueous medium, 990 parts of ion-exchanged water, 40 parts of a 25% aqueous dispersion of a particulate resin (a copolymer of styrene, methacrylic acid, butyl acrylate, and sodium salt of sulfate ester of ethylene oxide adduct of methacrylic acid), 145 parts of a 48.5% aqueous solution of dodecyl diphenyl ether disulfonic acid sodium (ELEMINOL MON-7 from Sanyo Chemical Industries, Ltd.), and 95 parts of ethyl acetate are mixed and agitated. Thus, a light-yellow aqueous medium (1) is prepared.

### (Emulsification)

Next, 975 parts of the colorant-wax dispersion (1) and 2.7 parts of isophorone diamine are mixed using TK HOMOMIXER (from Tokushu Kika Kogyo Co., Ltd.) for 1 minute at a revolution of 5000 rpm. Further, 90 parts of the isocyanate-modified polyester (1) are added thereto, and the mixture is mixed using the TK HOMOMIXER for 1 minute at a revolution of 5000 rpm. Furthermore, 1200 parts of the aqueous medium (1) prepared above are added thereto, and the mixture is mixed using the TK HOMOMIXER for 20 minutes at a revolution of from 8000 to 13000 rpm. Thus, an emulsion slurry (1) is prepared.

### (Solvent Removal)

The emulsion slurry (1) is contained in a vessel equipped with a stirrer and a thermometer, and subjected to solvent removal for 8 hours at 300C. Thus, a dispersion slurry (1) is prepared.

### (Washing and Drying)

Next, 100 parts of the dispersion slurry (1) is filtered under a reduced pressure to obtain a wet cake. The thus obtained wet cake is mixed with 100 parts of ion-exchange water and the mixture is agitated for 10 minutes by TK HOMOMIXER at a revolution of 12,000 rpm, followed by filtering. Thus, a wet cake (i) is prepared.

The wet cake (i) is mixed with 900 parts of ion-exchange water and the mixture is agitated for 30 minutes by TK HOMOMIXER at a revolution of 12,000 rpm with applying ultrasonic vibration, followed by filtering under a reduced pressure. This operation is repeated until the re-slurry has an electric conductivity of 10 μS/cm or less. Thus, a wet cake (ii) is prepared.

Further, 10% hydrochloric acid is added to the wet cake (ii) so that the re-slurry has a pH of 4, and the mixture is agitated for 30 minutes by a three-one motor, followed by filtering. Thus, a wet cake (iii) is prepared.

The wet cake (iii) is mixed with 100 parts of ion-exchange water and the mixture is agitated for 10 minutes by TK HOMOMIXER at a revolution of 12,000 rpm, followed by filtering. This operation is repeated until the re-slurry has an electric conductivity of 10 μS/cm or less. Thus, a wet cake (iv) is prepared.

The wet cake (iv) is dried for 48 hours at 42° C. using a circulating air drier, followed by sieving with a screen having openings of 75 μm. Thus, a mother toner (1) is prepared. The mother toner (1) has an average circularity of 0.976 (measured by a flow-type particle image analyzer FPIA-2000 from Sysmex Corp.), and a volume average particle diameter of 6.2 μm and a number average particle diameter of 5.8 μm (both measured by COULTER MULTISIZER III from Beckman Coulter K. K.).

Next, 100 parts of the mother toner (1) are mixed with 0.5 parts of a hydrophobized silica and 0.5 parts of a hydrophobized titanium oxide using HENSHEL MIXER. Thus, a toner (1) is prepared.

The toner (1) is set in the process cartridge illustrated in FIG. 2, and the process cartridge is mounted on an image forming apparatus IPSIO CX2500 (from Ricoh Co., Ltd.). A white solid image is continuously produced on 5 sheets of a paper PPC TYPE 6200T (from NBS Ricoh Co., Ltd.) at 24° C. and 45% RH. No background fouling is observed on the 5^{th} white solid image.

Next, the process cartridge is taken out of the apparatus and subjected to an accelerated durability test in which the developing roller is rotated for 40 minutes at 400 rpm. As a result, the conveyance surface of the developing roller is evenly formed. Furthermore, the control blade is taken out of the process cartridge, and toner particles adhered thereto are blown off by an air gun. As a result, no substance is firmly adhered to the control blade. The control blade is mounted on the process cartridge again, and the process cartridge is mounted on the IPSIO CX2500 again. A white solid image is continuously produced on 5 sheets of a paper PPC TYPE 6200T (from NBS Ricoh Co., Ltd.) at 24° C. and 45% RH. No background fouling is observed on the ₅th white solid image.

### (Evaluations)

Next, the toner (1) is subjected to an evaluation of fixability. The reliably evaluate separability, unfixed images are produced using a two-component developer.

Specifically, a two-component developer, in which 5 parts of the toner (1) and 95 parts of a silicone-resin-coated carrier are mixed, is set in a modified image forming apparatus IPSIO CX7500 (from Ricoh Co., Ltd.) from which the fixing device is removed. An unfixed solid image including 1±0.1 mg/cm² of toner particles is formed on 6 sheets of a paper PPC TYPE 6200Y (from NBS Ricoh Co., Ltd.) forming 3-mm-wide margin from a leading edge of the sheet.

On the other hand, a fixing device mounted on an image forming apparatus IPSIO CX2500 is taken out thereof, and modified so that temperature and linear velocity of the fixing belt are variable. The unfixed solid images prepared above are fixed using this modified fixing device at a temperature of the fixing belt of 140, 150, 160, 170, 180, and 190° C. each and a linear velocity of 125 mm/sec, so that the leading edge having the 3-mm-wide margin enters the fixing device first. As a result, the solid images are normally fixed on paper at every temperature without causing paper jam or toner adherence to the fixing belt.

Evaluation results are shown in Table 1. Each of the evaluated items is graded as follows.

### (1) Background Fouling:

A: No background fouling is observed. There is no visual difference between white solid image produced and a new sheet of paper.

B: Background fouling is slightly observed, but no problem in practical use.

C: Background fouling is observed. Not suitable for practical use.

D: Background fouling is notably observed. Not suitable for practical use.

### (2) Blade Adhesion

A: No substance is adhered to the blade.

B: A slight amount of substances are adhered to the blade, but no problem in practical use.

C: A certain amount of substances are adhered to the blade, but release from the blade when rubbed with a finger. The resultant image has white linear noise. Not suitable for practical use.

D: A certain amount of substances are adhered to the blade, and never release from the blade even when rubbed with a finger. The resultant image has white linear noise. Not suitable for practical use.

### (3) Fixability

A: 6 sheets are normally fixed. No problem in practical use.

B: 5 sheets are normally fixed. No problem in practical use.

C: 3 to 4 sheets are normally fixed. There is a possibility to cause trouble in practical use.

D: 2 or less sheets are normally fixed. Not suitable for practical use.

### Example 2

The procedure for preparation and evaluation of toner in Example 1 is repeated except that the isocyanate-modified polyester (1) is replaced with the isocyanate-modified polyester (2). Evaluation results are shown in Table 1.

### Example 3

The procedure for preparation and evaluation of toner in Example 1 is repeated except that 90 parts of the isocyanate-modified polyester (1) are replaced with 77 parts of the isocyanate-modified polyester (3). Evaluation results are shown in Table 1.

### Example 4

The procedure for preparation and evaluation of toner in Example 1 is repeated except that the isocyanate-modified polyester (1) is replaced with the isocyanate-modified polyester (4). Evaluation results are shown in Table 1.

### Example 5

The procedure for preparation and evaluation of toner in Example 1 is repeated except that the isocyanate-modified polyester (1) is replaced with the isocyanate-modified polyester (5). Evaluation results are shown in Table 1.

### Comparative Example 1

The procedure for preparation and evaluation of toner in Example 1 is repeated except that 90 parts of the isocyanate-modified polyester (1) are replaced with 77 parts of the isocyanate-modified polyester (6). Evaluation results are shown in Table 1.

### Comparative Example 2

The procedure for preparation and evaluation of toner in Example 1 is repeated except that 90 parts of the isocyanate-modified polyester (1) are replaced with 77 parts of the isocyanate-modified polyester (7). Evaluation results are shown in Table 1.

### Comparative Example 3

The procedure for preparation and evaluation of toner in Example 1 is repeated except that 90 parts of the isocyanate-modified polyester (1) are replaced with 77 parts of the isocyanate-modified polyester (8). Evaluation results are shown in Table 1.

### Comparative Example 4

The procedure for preparation and evaluation of toner in Example 1 is repeated except that 90 parts of the isocyanate-modified polyester (1) are replaced with 77 parts of the isocyanate-modified polyester (9). Evaluation results are shown in Table 1.

### Comparative Example 5

The procedure for preparation and evaluation of toner in Example 2 is repeated except that 77 parts of the isocyanate-modified polyester (7) are replaced with 51 parts of the isocyanate-modified polyester (7). Evaluation results are shown in Table 1.

TABLE 1

| | | | | | Evaluation Results | | | |
|---|---|---|---|---|---|---|---|---|
| | | Intermediate | | | | | Background | |
| | Isocyanate- | Polyester | | | | | Fouling | |
| | modified | | | f value | Blade | | Before | After |
| | Polyester # | Mn | OHV | (calcd.) | Adhesion | Fixability | Test | Test |
| Ex. 1 | 1 | 2700 | 57 | 2.74 | A | A | A | A |
| Ex. 2 | 2 | 3900 | 34 | 2.36 | B | A | A | B |
| Ex. 3 | 3 | 3800 | 51 | 3.45 | A | B | A | A |
| Ex. 4 | 4 | 1800 | 90 | 2.89 | A | B | A | B |
| Ex. 5 | 5 | 1600 | 82 | 2.34 | A | A | A | B |
| Comp. | 6 | 2200 | 52 | 2.04 | D | A | A | A |
| Ex. 1 | | | | | | | | |
| Comp. | 7 | 1400 | 94 | 2.35 | A | D | D | D |
| Ex. 2 | | | | | | | | |
| Comp. | 8 | 4300 | 39 | 2.99 | D | B | B | C |
| Ex. 3 | | | | | | | | |
| Comp. | 9 | 2600 | 78 | 3.61 | A | D | C | C |
| Ex. 4 | | | | | | | | |
| Comp. | 7 | 1400 | 94 | 2.35 | D | B | B | D |
| Ex. 5 | | | | | | | | |

* All toners of Examples 1 to 5 and Comparative Examples 1 to 5 each include a wax in an amount of 4% by weight.

This document claims priority and contains subject matter related to Japanese Patent Application No. 2007-183819, filed on Jul. 13, 2007, the entire contents of which are incorporated herein by reference.

Having now fully described the invention, it will be apparent to one of ordinary skill in the art that many changes and modifications can be made thereto without departing from the spirit and scope of the invention as set forth therein.

What is claimed as new and desired to be secured by Letters Patent of the United States is:

1. A toner, comprising:
a colorant;
a polyester (I); and
an urea-modified polyester,
wherein the urea-modified polyester is a reaction product of an isocyanate-modified polyester with an amine,
the isocyanate-modified polyester is obtained by modifying a polyester (II) with an isocyanate, and
the polyester (II) has a number average molecular weight (Mn) and a hydroxyl value [OHV] satisfying the following equations:
1500≦Mn≦4000
2.3≦[OHV]/1000/56.1×Mn≦3.5

2. The toner according to claim 1, wherein the toner is manufactured by dispersing or emulsifying a toner constituent liquid comprising the colorant, the polyester (I), and the isocyanate-modified polyester, in an aqueous medium.

3. The toner according to claim 1, wherein the polyester (I) has a number average molecular weight of from 1500 to 4000 and a weight average molecular weight of from 4000 to 10000.

4. The toner according to claim 1, wherein the polyester (I) has an acid value of from 18 to 40 mgKOH/g.

5. The toner according to claim 1, wherein the toner constituent liquid further comprises a release agent.

6. The toner according to claim 5, wherein the toner comprises the release agent in an amount of from 2 to 5% by weight.

7. The toner according to claim 5, wherein the release agent comprises a hydrocarbon wax.

8. The toner according to claim 5, wherein the release agent has an endothermic peak within a temperature range of from 60 to 90° C., measured by DSC (differential scanning calorimetry).

9. The toner according to claim 8, wherein the endothermic peak has a half bandwidth of equal to or less than 8° C.

10. A method for manufacturing a toner, comprising:
dispersing or emulsifying a toner constituent liquid comprising a colorant, a polyester (I), and an isocyanate-modified polyester, in an aqueous medium,
wherein the isocyanate-modified polyester is obtained by modifying a polyester (II) with an isocyanate, and
the polyester (II) has a number average molecular weight (Mn) and a hydroxyl value [OHV] satisfying the following equations:
1500≦Mn≦4000
2.3≦[OHV]/1000/56.1×Mn≦3.5

11. The method according to claim 10, wherein the polyester (I) has a number average molecular weight of from 1500 to 4000 and a weight average molecular weight of from 4000 to 10000.

12. The method according to claim 10, wherein the polyester (I) has an acid value of from 18 to 40 mgKOH/g.

13. The method according to claim 10, wherein the toner constituent liquid further comprises a release agent.

14. The method according to claim 13, wherein the toner comprises the release agent in an amount of from 2 to 5% by weight.

15. The method according to claim 13, wherein the release agent comprises a hydrocarbon wax.

16. The method according to claim 13, wherein the release agent has an endothermic peak within a temperature range of from 60 to 90° C., measured by DSC (differential scanning calorimetry).

17. The toner according to claim 16, wherein the endothermic peak has a half bandwidth of equal to or less than 8° C.

18. A process cartridge, comprising:
an image bearing member configured to bear an electrostatic latent image; and
a developing device configured to develop the electrostatic latent image with a toner,
wherein the developing device comprises:
a toner containing chamber containing the toner;
a toner conveyance member;
a toner supply member configured to supply the toner contained in the toner containing chamber to a surface of the toner conveyance member; and
a toner control member provided in contact with the surface of the toner conveyance member, configured to control a thickness of the toner supplied to the surface of the toner conveyance member, and
wherein the toner is the toner according to claim 1.
